(19) United States
(12) Patent Application Publication
(10) Pub. No.: US 2005/0147861 A1
(43) Pub. Date: Jul. 7, 2005

(54) Proton conducting electrolyte and fuel cell using the same

(75) Inventors: Atsuo Sonai, Yokohama (JP); Toshihiko Matsuda, Shimogyo-ku (JP)

Correspondence Address: MCGUIREWOODS, LLP, 1750 TYSONS BLVD, SUITE 1800, MCLEAN, VA, 22102, US

(73) Assignee: Samsung SDI Co., Ltd.

(21) Appl. No.: 11/008,613

(22) Filed: Dec. 10, 2004

(30) Foreign Application Priority Data
Dec. 11, 2003 (JP) 2003-413246
Dec. 7, 2004 (KR) 10-2004-0102208

(51) Int. Cl. H01M 8/10; H01M 4/86; C08J 5/22

(52) U.S. Cl. 429/33; 429/42; 521/25

(57) ABSTRACT

The present invention is related to a proton conducting electrolyte having better proton conductivity, heat resistance and mechanical strength and a fuel cell using the same. More specifically, the proton conducting electrolyte of the present invention comprises a backbone polymer having a hard segment and a soft segment, and one or both of a side chain polymer having a proton dissociating group and a side chain polymer composed of a dendrimer.

### CROSS-REFERENCE TO RELATED APPLICATIONS

This application claims the priority to Japanese Patent Application No. 2003-413246, filed on Dec. 11, 2003, in the Japanese Intellectual Property Office and priority to Korean Patent Application No. 2004-102208, filed on Dec. 7, 2004, in the Korean Intellectual Property Office, the disclosures of which are incorporated herein in their entirety by reference.

### FIELD OF THE INVENTION

The present invention is related to a proton conducting electrolyte and a fuel cell using the same. Specifically, the proton conducting electrolyte of the present invention has better heat resistance and proton conductivity.

### BACKGROUND

Due to the deterioration of the global environment, the development and use of clean energy is required all over the world. For example, with regard to the traffic field, with the development of traffic networks and the increase of the number of vehicles, the air pollution problem due to the exhaust gas of internal combustion engines of automobiles has become very serious. As a solution to this problem, electric automobiles or hybrid cars has been developed. Alternatively, the use of a fuel cell, which is light, can be easily handled, and does not contaminate the air, may be used as an energy source for automobiles. The fuel cell can also be used as an energy source for home accommodations.

Fuel cells can be classified into alkaline fuel cells, phosphoric acid fuel cells, molten carbonate fuel cells, solid electrolyte fuel cells, and solid polymer fuel cells depending on the electrolyte type. Among these fuel cells, the solid polymer fuel cell, which is operable at low temperatures, can be easily handled, and has high output power, is emerging as the future energy source for electric automobiles, and home accommodations.

A proton conducting membrane used for solid polymer fuel cells should have high ion conductivity for protons involved in electrode reaction of a fuel cell. This proton conducting membrane composed of a fluorine-based polymer containing a super-acid group is known. However, since such a polymer is a fluorine-based material, it is very expensive. In addition, since the proton conducting medium is water, water must be supplied by continuous humidification.

Japanese Patent Publication Nos. 2002-280019 and 2002-358978 disclose a membrane containing an ion dissociating group, such as a carboxylic acid group, a sulfonic acid group and a phosphoric acid group, in an aromatic skeleton so as to have proton conductivity. However, since such an ion dissociating group is separated at high temperatures, the membrane has poor heat resistance, poor flexibility and poor proton conductivity.

### SUMMARY OF THE INVENTION

An object of the present invention is related to a proton conducting membrane having good proton conductivity, heat resistance, and mechanical strength. Additionally, the present invention is related to a fuel cell using the same.

An aspect of the present invention is directed to a proton conducting electrolyte comprising a backbone polymer having a hard segment and a soft segment, and one or both of a side chain polymer having a proton dissociating group and a side chain polymer comprising a dendrimer. By using this structure, a proton conducting membrane may be fabricated having good proton conductivity, good heat resistance, and good mechanical strength.

In one particular aspect, the hard segment in the proton conducting electrolyte may be formed by a reaction of polyisocyanate having any one among aromatic, heterocyclic and alicyclic rings and any one compound of an acid anhydride, a polyamine compound and a polyol compound. Furthermore, the polyisocyanate and the compound may be bound to each other by, for example, imide groups, urea groups or urethane groups.

In another particular aspect, the soft segment in the proton conducting electrolyte may have a polyoxyalkylene chain and may be bound to the hard segment by one or both of urea and urethane groups, for example. In the proton conducting electrolyte, the backbone polymer may have a pyrolysis temperature greater than about 220° C. and a storage modulus at about 200° C. in the range of about 1×10⁷ Pa to about 1×10⁹ Pa.

In a further aspect, the proton dissociating group in the proton conducting electrolytes any one among a sulfonic acid group, a carboxylic acid group and a phosphoric acid group. In the proton conducting electrolyte, the side chain polymer may be composed of a dendrimer, such as a polyacrylate having at least a polyethyleneoxide chain and at least two groups, such as an amino group, a hydroxyl group or a sulfonic acid group, for example at a terminal of the polyethyleneoxide chain.

Another aspect of the present invention is directed to a fuel cell comprising a pair of electrodes and an electrolyte membrane interposed between the electrodes. Moreover, the electrolyte membrane may be composed of the proton conducting electrolyte of the present invention and the proton conducting electrolyte may be positioned in a part of the electrodes. Accordingly, a high-performance fuel cell having good electric power generating property may be obtained.

### BRIEF DESCRIPTION OF THE DRAWINGS

FIG. 1 schematically illustrates the molecular structure of a proton conducting electrolyte according to an embodiment of the present invention.

### DETAILED DESCRIPTION OF THE INVENTION

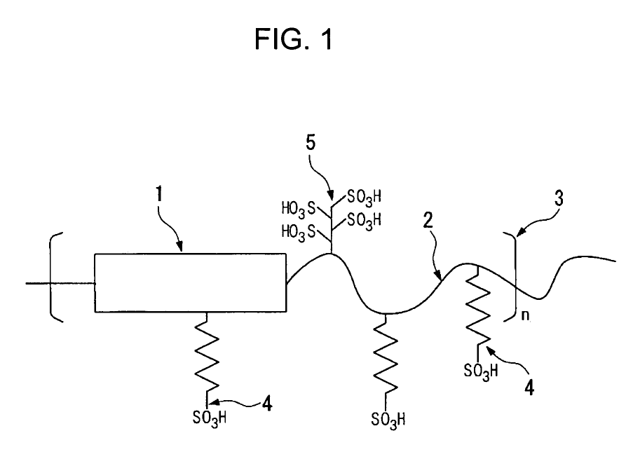

Referring to FIG. 1, which illustrates an embodiment of the present invention, the proton conducting electrolyte includes a backbone polymer 3 having a hard segment 1 and a soft segment 2 and one or both of a side chain polymer 4 having a proton dissociating group and a side chain polymer 5 composed of a dendrimer.

The hard segment 1 may be formed by a reaction of polyisocyanate and a compound, such as an acid anhydride, a polyamine compound or a polyol compound, for example. The hard segment 1 may be bound to the soft segment 2 by one or both of urea and urethane groups. The binding of the hard segment 1 and the soft segment 2 occurs at an NCO index in the range of about 90 to about 110. Due to the hard segment 1, heat resistance of the proton conducting electrolyte may be improved.

Polyisocyanate for the hard segment 1 may have one ring comprising an aromatic ring, a heterocyclic ring or an alicyclic ring. Examples of the aromatic ring may include, but are not limited to, benzene, naphthalene, anthracene and fullerene rings. In a particular embodiment, the hard segment comprises benzene and naphthalene rings. Examples of the heterocyclic ring include those having oxygen, nitrogen or sulfur. In particular, heterocyclic rings having oxygen or nitrogen may be used. The alicyclic ring can be one of those known in the art and is not particularly limited.

In a further embodiment, the acid anhydride, polyamine compound or polyol compound for the hard segment 1 may be reacted with polyisocyanate to form an imide group, an urea group or an urethane group, respectively. That is, the imide group may be formed by a reaction of polyisocyanate and a polybasic acid anhydride, the urea group may be formed by a reaction of polyisocyanate and a polyamine compound, and the urethane group may be formed by a reaction of polyisocyanate and a polyol compound.

The polyisocyanate may include the following compounds, but is not limited to: a compound having an aromatic ring including, for example, toluene diisocyanate, diphenylmethane diisocyanate (hereinafter, abbreviated as MDI), xylene diisocyanate, naphthalene and diisocyanate; a compound having an alicyclic ring including isophorone diisocyanate, cyclohexane and diisocyanate; and an aliphatic compound including hexamethylene diisocyanate, and lysine diisocyanate. Any derivative of the above compounds may also be used. Additionally, these compounds may be used in combination if necessary. NCO % of the polyisocyanate is commonly in the range of about 20% to about 48%, and more specifically, in the range of about 25% to about 48%. A NCO % not within this range, will reduce both heat resistance and mechanical strength.

In another embodiment, examples of the polybasic acid anhydride may include, but are not limited to, pyromellitic anhydride, trimellitic anhydride, benzene tetracarboxylic acid dianhydride, and naphthalenetetracarboxylic acid dianhydride. Additionally, examples of the polyamine compound may include aliphatic diamines (ethylene diamine, propylene diamine, etc.), alicyclic diamine (isophorone diamine, etc.), and aromatic diamine (polytetramethyleneoxide-di-p-aminobenzoate, 4,4′-diamino-3,3′-diethylamino-5,5′-diaminodiphenylmethane, 2,2′,3,3′-tetrachloro-4,4′-diaminodiphenylmethane, 3,3′-dichloro-4,4′-diaminodiphenylmethane, trimethylene-bis(4-aminobenzoate), and 3,5-dimethylthiotoluenediamine, etc.). These compounds may also be used in combination. In a specific embodiment, the polyamine compounds of alicyclic diamines and aromatic diamines may be used. An amine value is commonly in the range of about 250 to about 500, and more specifically in the range of about 300 to about 500. An amine value not within this range will reduce both heat resistance and mechanical strength.

Moreover, examples of the polyol compound may include, but are not limited to, aliphatic diols (ethyleneglycol, propyleneglycol, etc.) and aromatic diols (hydroquinone, bisphenol A, etc.). Hydroxyl value is commonly in the range of about 250 to about 500, and specifically in the range of about 300 to about 500. A hydroxyl value not within this range will reduce both heat resistance and mechanical strength.

The soft segment 2 may have a polyoxyalkylene chain and may be bound to the hard segment 1 by one or both of urea and urethane groups. The soft segment 2 provides the backbone polymer 3 with flexibility, thereby improving proton conductivity. Examples of the polyoxyalkylene chain for the soft segment 2 may include polyethyleneoxide, polypropyleneoxide, and polytetrahydrofuranoxide chains, for example. In particular, polyethyleneoxide and polytetrahydrofuranoxide chains are preferable in terms of proton conductivity and mechanical property.

The soft segment 2 may have a polyoxyalkylene chain in a molecule and a hydroxy or amino group at a terminal of the molecule. Examples of such a segment may include polyoxyalkyleneglycol and polyalkyleneoxide-di-P-aminobenzoate with hydroxy values or amine values in the range of about 28 to about 200, and in particular, in the range of about 28 to about 150. Any value out of this range will reduce mechanical strength.

In a specific embodiment, the backbone polymer 3 has a hydrolysis temperature of greater than about 220° C. and a storage modulus at about 200° C. in the range of about 1×10⁷ Pa to about 1×10⁹ Pa. Any values not within this range, will not permit the desired heat resistance or mechanical properties to be obtained.

In a particular embodiment, the side chain polymer 4 may have a proton dissociating group at a terminal. Examples of the proton dissociating group may include, but are not limited to, a sulfonic acid group, a carboxylic acid group and a phosphoric acid group. The sulfonic acid group and phosphoric acid group are preferable. The side chain polymer 4 is not particularly limited, but is preferably poly(meth)acrylate. Examples of the side chain polymer 4 are as follows. The side chain polymer having a sulfonic acid group as the proton dissociating group may include poly(2-acrylamide-2-methylpropanesulfonic acid) (hereinafter, abbreviated as TBAS), and polystyrenesulfonic acid. The side chain polymer having a carboxylic acid group as the proton dissociating group may include polyacrylic acid, poly(β-methacroyloxyethylhydrogensuccinate), and poly(β-methacroyloxyethylhydrogenphthalate). The side chain polymer having a phosphoric acid group as the proton dissociating group may include poly[mono(2-acryloyloxyethyl)phosphate], and poly[mono(2-methacroyloxyethyl)phosphate]. These polymers may be obtained according to methods known in the art by radical polymerization or photopolymerization from the respective monomers.

In another embodiment, the side chain polymer 5 may comprise a dendrimer, such as poly(meth)acrylate having at least a polyethyleneoxide chain and at least two groups such as an amino group, a hydroxyl group and a sulfonic acid group at a terminal. Specifically, the side chain polymer 5 may be a material obtained according to methods known in the art by adding alkyleneoxide including ethylene oxide to a compound having three or more hydroxyl groups in the molecule (trimethylolpropane, pentaerythritol etc.) and then react the resulting adduct with methacrylisocyanate and finally performing a radical polymerization or photopolymerization.

In a further embodiment, the side chain polymer 4 and the side chain 5 may be obtained by polymerizing the respective monomers in the backbone polymer 3. The ratio of the backbone polymer 3, the side chain polymer 4 and the side chain polymer 5 is not particularly limited, but the side chain polymer 4 may be in the range of about 0.1 parts to about 1 part by weight and the side chain polymer 5 may be in the range of about 0.01 parts to about 1 part by weight based on 1 part by weight of the backbone polymer 3. More specifically, the side chain polymer 4 may be in the range of about 0.3 parts to about 1 part by weight and the side chain polymer 5 may be in the range of about 0.01 parts to about 0.5 part by weight based on 1 part by weight of the backbone polymer 3.

Another embodiment of the present invention is directed to a fuel cell. The fuel cell may comprise a pair of electrodes and an electrolyte membrane interposed between the electrodes. Additionally, the electrolyte membrane may be composed of the proton conducting electrolyte of the present invention and the proton conducting electrolyte may be contained in a part of the electrodes. That is, the fuel cell may include an electrolyte membrane composed of the proton conducting electrolyte and a cathode and an anode attached to both sides of the electrolyte.

In a further embodiment, hydrogen in the anode of a fuel may be electrochemically oxidized to produce protons and electrons. The protons may be transferred to the cathode through the electrolyte membrane. The electrons produced in the anode runs to the cathode through a load connected to the fuel cell. In the cathode, the protons, oxygen supplied from external source and the electrons react to produce water.

The anode and the cathode for the fuel cell may further comprise a conductive material, a binder and a catalyst. The conductive material may be any electroconductive material and examples thereof include various metals and carbon materials. Examples of the conductive materials include carbon black such as acetylene black, activated carbon, and graphite. These materials may be used alone or in combination. The catalyst can be any metal capable of promoting oxidization of hydrogen and reduction of oxygen. Examples of such a metal may include, but are not limited to, Pb, Fe, Mn, Co, Cr, Ga, V, W, Ru, Ir, Pd, Pt, Rh or alloys thereof.

In a specific embodiment, the proton conducting electrolyte may be used as the binder. The binder may include other resin in addition to the proton conducting electrolyte. In this case, the resin is may be a fluorine resin with water repellency. More specifically, the fluorine resin has a melting point of less than about 400° C. and examples thereof include polytetrafluoroethylene, tetrafluoroethylene-perfluoroalkylvinylether copolymer, and the like.

### EXAMPLES

Proton conductivity: Two Pt wires (diameter: 0.2 mm) were placed 5 mm apart on the surface of a short-book shaped sample to form electrodes. When AC (1 kHz) was applied to the electrodes, a resistance was measured by means of an impedance analyzer. The proton conductivity was calculated by an electrode distance and an equation 1/(R×t×D) from a resistance gradient (R), a thickness (t) of the sample and a width (D) of the sample. The measurement was conducted at 80° C. and humidity of 95%.

Storage modulus: The measurement was conducted by means of a viscoelasticity meter (Rheogel-E4000, UBM) at a heating rate of 2° C./min, temperature range of 20-230° C., frequency of 100 Hz and displacement of 5 μm.

### Specific Example 1

20.8 parts by weight of MDI and 100 parts by weight of polytetramethyleneoxide-di-P-aminobenzoate (amine value: 89) were mixed and dissolved in 400 parts by weight of tetrahydrofuran. The resulting solution was injected into a fluorine resin schale and tetrahydrofuran was removed, thereby obtaining a backbone polymer of Example 1. A viscoelasticity of the obtained backbone polymer was measured. As a result, a storage modulus at about 200° C. was about 4×10⁷ Pa and the pyrolysis temperature was about 250° C.

### Specific Example 2

25.7 parts by weight of MDI, 50 parts by weight of polytetramethyleneoxide-di-P-aminobenzoate (amine value: 89) and 50 parts by weight of polytetramethyleneoxide-di-P-aminobenzoate (amine value: 132) were mixed and dissolved in 400 parts by weight of tetrahydrofuran. The resulting solution was injected into a fluorine resin schale and tetrahydrofuran was removed, thereby obtaining a backbone polymer of Example 2. A viscoelasticity of the resultant backbone polymer was measured. As a result, a storage modulus at about 200° C. was about 8×10⁷ Pa and the pyrolysis temperature was about 270° C.

### Specific Example 3

1 part by weight of the backbone polymer prepared in Example 1, 1 part by weight of TBAS (50% aqueous solution) as a side chain polymer 4, 0.01 part by weight of 2-hydroxy-2-methylpropiophenone as a polymerization initiator and 6 parts by weight of tetrahydrofuran were mixed and degassed. Then, the mixture was irradiated with ultra violet rays (400 W mercury lamp) for 7 minutes. Then, the resultant was washed with hot water (80° C.) for 1 hour and dried. Thus, a proton conducting electrolyte of Example 3 was prepared. The proton conductivity of the resultant proton conducting electrolyte was about 6.1×10⁻³ S/cm. Proton conductivity of the backbone polymer of Example 1 was about 3×10⁻⁶ S/cm. As apparent from the results, the proton conductivity can be improved by adding the side chain polymer 4 to the backbone polymer.

### Specific Example 4

A proton conducting electrolyte of Example 4 was prepared in the same manner as in Example 3, except that 1 part by weight of the backbone polymer prepared in Example 2, 2 parts by weight of TBAS (50% aqueous solution) as a side chain polymer 4, 0.01 part by weight of 2-hydroxy-2-methylpropiophenone as a polymerization initiator, 0.3 part by weight of a product obtained by reacting 10 parts by weight of an addition product (hydroxyl value of 545) of ethyleneoxide to pentaerythritol and 3.7 parts by weight of 2-methacroyloxyethylisocyanate, and 6 parts by weight of tetrahydrofuran were mixed.

Proton conductivity of the obtained proton conducting electrolyte was about 1×10⁻³ S/cm. The proton conductivity of the backbone polymer of Example 2 was about 3×10⁻⁶ S/cm. As apparent from the results, the proton conductivity can be improved by adding the side chain polymers 4 and 5 to the backbone polymer.

### Specific Example 5

A fuel cell was manufactured using the proton conducting electrolyte of Example 3. Pt/C catalyst with 30% Pt supported on carbon was dispersed in a polymer solution of tetrahydrofuran (the solution in Example 3) and the solvent was removed to form a catalyst layer. The resultant was used as electrodes. Then, the electrolyte membrane of Example 3 was interposed between the electrodes. Air and hydrogen were used to generate electric power at about 80° C. As a result, a cell voltage of about 0.66 V was obtained at a current density of about 0.3 A/cm².

According to the proton conducting electrolyte of the present invention, proton conductivity, heat resistance and mechanical strength can be improved. According to the fuel cell of the present invention, a high performance fuel cell with good electric power generating property can be provided.

While the present invention has been particularly shown and described with reference to exemplary embodiments thereof, it will be understood by those of ordinary skill in the art that various changes in form and details may be made therein without departing from the spirit and scope of the present invention as defined by the following claims.

1. A proton conducting electrolyte, comprising:
a backbone polymer comprising a hard segment and a soft segment, and one or both of a side chain polymer comprising a proton dissociating group and a side chain polymer composed of a dendrimer.

2. The proton conducting electrolyte of claim 1, wherein the hard segment is formed by a reaction of a polyisocyanate comprising:
a ring structure selected from the group consisting of an aromatic ring, a heterocyclic ring and an alicyclic ring, and
one or more compounds selected from the group consisting of an acid anhydride, a polyamine compound and a polyol compound, and
wherein the polyisocyanate and the compound are bound to each other by a group selected from the group consisting of imide group, a urea group and an urethane group.

3. The proton conducting electrolyte of claim 1, wherein the soft segment has a polyoxyalkylene chain and is bound to the hard segment by one or more selected from the group consisting of a urea group and an urethane group.

4. The proton conducting electrolyte of claim 1, wherein the backbone polymer has a pyrolysis temperature of greater than about 220° C. and a storage modulus at about 200° C. in the range of about 1×10⁷ Pa to about 1×10⁹ Pa.

5. The proton conducting electrolyte of claim 1, wherein the proton dissociating group is selected from the group consisting of a sulfonic acid group, a carboxylic acid group and a phosphoric acid group.

6. The proton conducting electrolyte of claim 1, wherein the side chain polymer composed of a dendrimer is polyacrylate having at least a polyethyleneoxide chain and at least two groups selected from the group consisting of an amino group, a hydroxyl group, and sulfonic acid group at a terminal of the polyethyleneoxide chain.

7. A fuel cell, comprising:
a pair of electrodes; and
an electrolyte membrane interposed between the electrodes, wherein the electrolyte membrane is a proton conducting electrolyte comprising:
a backbone polymer comprising a hard segment and a soft segment, and one or both of a side chain polymer comprising a proton dissociating group and a side chain polymer composed of a dendrimer, and
wherein the proton conducting electrolyte is contained in a part of the electrodes.

8. The fuel cell of claim 7, wherein the hard segment is formed by a reaction of a polyisocyanate comprising:
a ring structure selected from the group consisting of an aromatic ring, a heterocyclic ring and an alicyclic ring, and
one or more compounds selected from the group consisting of an acid anhydride, a polyamine compound and a polyol compound, and
wherein the polyisocyanate and the compound are bound to each other by a group selected from the group consisting of imide group, a urea group and an urethane group.

9. The fuel cell of claim 7, wherein the soft segment has a polyoxyalkylene chain and is bound to the hard segment by one or more selected from the group consisting of a urea group and an urethane group.

10. The fuel cell of claim 7, wherein the backbone polymer has a pyrolysis temperature of greater than about 220° C. and a storage modulus at about 200° C. in the range of about 1×10⁷ Pa to about 1×10⁹ Pa.

11. The fuel cell of claim 7, wherein the proton dissociating group is selected from the group consisting of a sulfonic acid group, a carboxylic acid group and a phosphoric acid group.

12. The fuel cell of claim 7, wherein the side chain polymer composed of a dendrimer is polyacrylate having at least a polyethyleneoxide chain and at least two groups selected from the group consisting of an amino group, a hydroxyl group, and sulfonic acid group at a terminal of the polyethyleneoxide chain.
